(19) United States
(12) Patent Application Publication
(10) Pub. No.: US 2026/0017692 A1
(43) Pub. Date: Jan. 15, 2026

(54) INFORMATION RECOMMENDATION METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, SHENZHEN (CN)

(72) Inventors: Jinchao ZENG, SHENZHEN (CN); Zirui CHENG, SHENZHEN (CN); Chuanyu ZHANG, SHENZHEN (CN); Shuyuan LI, SHENZHEN (CN); Yitong WANG, SHENZHEN (CN); Jianing NING, SHENZHEN (CN); Qiming LI, SHENZHEN (CN); Yaqi LUO, SHENZHEN (CN); Yunjia QIAO, SHENZHEN (CN); Bingyi WU, SHENZHEN (CN); Fei LI, SHENZHEN (CN); Longfei LI, SHENZHEN (CN); Tongyi GUO, SHENZHEN (CN)

(73) Assignee: TENCENT TECHNOLOGY (SHENZHEN) COMPANY LIMITED, SHENZHEN (CN)

(21) Appl. No.: 19/332,319

(22) Filed: Sep. 18, 2025

Related U.S. Application Data
(63) Continuation of application No. PCT/CN2024/093965, filed on May 17, 2024.

(30) Foreign Application Priority Data
Jul. 14, 2023 (CN) 202310869969.1

(51) Int. Cl. G06Q 30/0251

(52) U.S. Cl. CPC G06Q 30/0271

(57) ABSTRACT

The present disclosure describes methods, apparatus, devices, and products for information recommendation. The method includes: displaying a news feed in a news feed interface, where first recommendation information is inserted into the news feed; displaying an object material of an object recommended by the first recommendation information; controlling, in response to a slide operation on the news feed interface, the object material to move; and controlling, in response to the object material moving to a region of second recommendation information in the news feed, the object material to generate at least one piece of interaction content with the second recommendation information, where an object recommended by the second recommendation information is the same as or similar to the object recommended by the first recommendation information.

### RELATED APPLICATION

This application is a continuation application of PCT Patent Application No. PCT/CN2024/093965, filed on May 17, 2024, which claims priority to and is based on Chinese Patent Application No. 202310869969.1, filed on Jul. 14, 2023, both of which are incorporated herein by reference in their entireties.

### FIELD OF THE TECHNOLOGY

The present disclosure relates to the field of Internet technologies, and in particular, to an information recommendation method and apparatus, an electronic device, a computer-readable storage medium, and a computer program product.

### BACKGROUND OF THE DISCLOSURE

Using an advertisement pushing scenario as an example, in related technologies, a focus map advertisement and a news feed advertisement (for example, an initial news feed advertisement) are usually two advertisement locations independent of each other, and advertisement content (for example, an image, a video, and text information) of the focus map advertisement and the news feed advertisement are respectively pushed. There is no association between the focus map advertisement and the news feed advertisement, causing disordered advertisement presentation and low efficiency of obtaining information satisfying a requirement of a user. Another problem/issue for a conventional focus map advertisement and news feed advertisement may include a limited region/display size, limiting presentation of content and product details of the advertiser.

The present disclosure describes various embodiments providing information recommendation methods by correlating a focus map advertisement with a news feed advertisement, addressing at least one problem/issue discussed in the present disclosure, enhancing the ability to attract user's attention, increasing a conversion rate of an advertisement, and/or improving user experience in an APP, leading to improvement in the effective advertisement field.

### SUMMARY

Embodiments of the present disclosure provide an information recommendation method and apparatus, an electronic device, a computer-readable storage medium, and a computer program product, to optimize a presentation manner of recommendation information, thereby effectively improving efficiency of obtaining information by a user.

Technical solutions of the embodiments of the present disclosure are implemented as follows:

An embodiment of the present disclosure provides an information recommendation method, performed by an electronic device, and the method including:
displaying a news feed in a news feed interface, where first recommendation information is inserted into the news feed;
displaying an object material of an object recommended by the first recommendation information;
controlling, in response to a slide operation on the news feed interface, the object material to move; and
controlling, in response to the object material moving to a region of second recommendation information in the news feed, the object material to generate at least one piece of interaction content with the second recommendation information, and an object recommended by the second recommendation information being the same as or similar to the object recommended by the first recommendation information.

An embodiment of the present disclosure provides an information recommendation apparatus, including:
a display module, configured to display a news feed in a news feed interface, first recommendation information being inserted into the news feed, and
the display module being further configured to display an object material of an object recommended by the first recommendation information; and
a control module, configured to control, in response to a slide operation on the news feed interface, the object material to move, and
the control module being further configured to control, in response to the object material moving to a region of second recommendation information in the news feed, the object material to generate at least one piece of interaction content with the second recommendation information, and an object recommended by the second recommendation information being the same as or similar to the object recommended by the first recommendation information.

An embodiment of the present disclosure provides an electronic device, including:
a memory, configured to store executable instructions; and
a processor, configured to perform, when executing the executable instructions stored in the memory, the information recommendation method provided in the embodiments of the present disclosure.

An embodiment of the present disclosure provides a computer-readable storage medium, having computer-executable instructions stored therein, and the computer-executable instructions, when executed by a processor, implementing the information recommendation method provided in the embodiments of the present disclosure.

An embodiment of the present disclosure provides a computer program product, including a computer program or computer-executable instructions, and the computer program or computer-executable instructions, when executed by a processor, being configured to implement the information recommendation method provided in the embodiments of the present disclosure.

The embodiments of the present disclosure have the following beneficial effects:

An object material is presented in a larger area in a manner of correlating two pieces of recommendation information that are originally independent of each other, and after the object material is controlled to move to a region of second recommendation information in a news feed, the object material may be controlled to generate interaction content with the second recommendation information. In this way, information about an object recommended by first recommendation information can be presented more comprehensively in a larger range, that is, a presentation manner of the recommendation information is optimized, thereby effectively improving efficiency of obtaining information satisfying a requirement of a user.

### BRIEF DESCRIPTION OF THE DRAWINGS

FIG. 1 is a schematic diagram of an architecture of an information recommendation system 100 according to an embodiment of the present disclosure.

FIG. 2 is a schematic diagram of a structure of an electronic device 500 according to an embodiment of the present disclosure.

FIG. 3 is a schematic flowchart of an information recommendation method according to an embodiment of the present disclosure.

FIG. 4A and FIG. 4B are schematic diagrams of application scenarios of an information recommendation method according to an embodiment of the present disclosure.

FIG. 5 is a schematic flowchart of an information recommendation method according to an embodiment of the present disclosure.

FIG. 6A and FIG. 6B are schematic diagrams of application scenarios of an information recommendation method according to an embodiment of the present disclosure.

FIG. 7 is a schematic flowchart of an information recommendation method according to an embodiment of the present disclosure.

FIG. 8 is a schematic flowchart of an information recommendation method according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the related art without creative efforts shall fall within the protection scope of the present disclosure.

In the following descriptions, the term “some embodiments” describes subsets of all possible embodiments, but “some embodiments” may be the same subset or different subsets of all the possible embodiments, and may be combined with each other without conflict.

In the embodiments of the present disclosure, related data such as user information (for example, biological feature data such as a palm print or a human face of a user) is involved. When the embodiments of the present disclosure are applied to a specific product or technology, user permission or consent needs to be obtained, and collection, use, and processing of the related data needs to comply with related laws and regulations and standards.

In the following descriptions, the term “first/second/ . . . ” involved is merely configured for distinguishing between similar objects and does not represent a specific order of objects. “first/second/ . . . ” may be transposed for a specific order or a sequence when allowed, so that the embodiments of the present disclosure described herein can be implemented in an order other than those illustrated or described herein.

In the embodiments of the present disclosure, the term “module” or “unit” is a computer program having a predetermined function or a part of a computer program, operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or the unit.

Unless otherwise defined, meanings of all technical and scientific terms used in the embodiments of the present disclosure are the same as those generally understood by a person skilled in the technical field belonging to the present disclosure. Terms used in the embodiments of the present disclosure are merely intended to describe purposes of the embodiments of the present disclosure and are not intended to limit the embodiments of the present disclosure.

Before the embodiments of the present disclosure are further described in detail, terms involved in the embodiments of the present disclosure are described, and the following explanations are applicable to the terms involved in the embodiments of the present disclosure.

1) “In response to” is configured for representing a condition or state on which a performed operation depends. When the condition or state on which the performed operation depends is met, one or more performed operations may be performed in real time, or may be performed after a set delay. Unless particularly described, a plurality of performed operations are not limited to an execution sequence.

2) A “focus map advertisement” is usually formed by a main image and a plurality of supplementary images, and each supplementary image is provided with a title, a description, and a link. A user may browse different images or videos by means of sliding or tapping, to learn about more information about a product, a service, or a brand.

3) A “news feed advertisement” is usually presented in a form of an image, a title, and a brief description, which is similar to publishing of news, an article, or social media. They appear in locations such as a social media timeline of the user, a content stream of a news website, or a recommendation region in a mobile application. Different from a conventional advertisement, the news feed advertisement is not definitely denoted as an advertisement on a page, but is integrated into browsing experience of the user in a natural manner.

4) A “news feed” is a series of information arranged in a particular manner, for example, a photo stream arranged according to shooting time, a news stream arranged according to occurrence time, a social friend status stream arranged according to updating time, or a video stream arranged according to popularity (for example, a click-through rate).

5) A “gesture interaction” is an interaction with an advertisement which is completed through a gesture such as sliding or inclining.

6) A “Bezier curve” is a curve described by using a mathematical method and is widely applied to computer graphics and animation. In a vector diagram, the Bezier curve may be configured for defining a smooth curve that can be infinitely enlarged. The Bezier curve may be described by at least two control points. A cubic Bezier curve is usually used in a network (Web) technology, to be specific, a curve described by using four control points P0, P1, P2, and P3.

Embodiments of the present disclosure provide an information recommendation method and apparatus, an electronic device, a computer-readable storage medium, and a computer program product, to optimize a presentation manner of recommendation information, thereby effectively improving efficiency of obtaining information by a user. An electronic device provided in an embodiment of the present disclosure is described below. The electronic device provided in this embodiment of the present disclosure may be implemented as a terminal device, or may be cooperatively implemented by the terminal device and a server. Descriptions are provided below by using an example in which the terminal device and the server cooperate to implement the information recommendation method provided in an embodiment of the present disclosure.

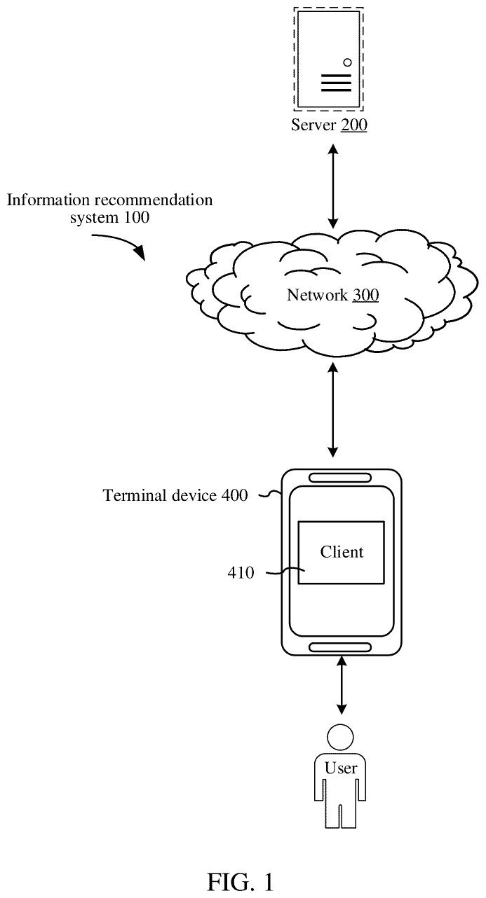

Exemplarily, FIG. 1 is a schematic diagram of an architecture of an information recommendation system 100 according to an embodiment of the present disclosure. To implement a presentation manner of supporting and optimizing recommendation information and then to improve efficiency of obtaining information by a user, as shown in FIG. 1, the information recommendation system 100 includes: a server 200, a network 300, and a terminal device 400. The network 300 may be a local area network, a wide area network, or a combination thereof. The terminal device 400 is a terminal device associated with the user. A client 410 is run on the terminal device 400. The client 410 may be various types of clients, for example, including a news reading client, an instant messaging client, an e-commerce shopping client, a video playing client, an audio playing client, and a browser.

In some embodiments, an example in which the client 410 is the video playing client is used. When a tapping operation performed by the user on an icon of the client 410 which is displayed on a screen of the terminal device 400 is received, a news feed interface may be displayed, and a news feed (for example, a video stream arranged according to updating time) may be displayed in the news feed interface. First recommendation information (for example, a focus map advertisement) may be inserted into the news feed. For example, the focus map advertisement may be inserted into the top of the video stream. Then, when display duration of the first recommendation information reaches a duration threshold (for example, 5 seconds), or a slide operation (for example, an upward slide operation) triggered by the user on the news feed is received, an object material (for example, a handbag material) of an object (for example, a handbag of a brand) recommended by the first recommendation information may be displayed in the news feed interface, and the object material is controlled to move relative to the news feed. Finally, the client 410 may control, in response to the object material moving to a region of second recommendation information (for example, an initial news feed advertisement) inserted into the news feed, the object material to generate at least one piece of interaction content with the second recommendation information. For example, the object material may be controlled to stay in the region of the second recommendation information. An object recommended by the second recommendation information is the same as the object recommended by the first recommendation information. In this way, the focus map advertisement (namely, the first recommendation information) and the news feed advertisement (namely, the second recommendation information) are connected by using the object material, to form an advertisement content presentation region larger than one screen, thereby expanding space for ideas of an advertiser, increasing a conversion rate of the advertisement provided by the advertiser, and improving user experience.

In some other embodiments, the embodiments of the present disclosure may further be implemented by using a cloud technology. The cloud technology is a hosting technology that unifies a series of resources such as hardware, software, and networks in a wide area network or a local area network to implement computing, storage, processing, and sharing of data.

The cloud technology is a general term for a network technology, an information technology, an integration technology, a management platform technology, an application technology, and the like applied based on a business mode of cloud computing, and may form a resource pool used on demand flexibly and conveniently. The cloud computing technology is becoming an important support. Background services of a technical network system require a large quantity of computing and storage resources.

Exemplarily, the server 200 in FIG. 1 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal device 400 may be a smartphone, a tablet computer, a notebook computer, a desktop computer, a smart speaker, a smart watch, an in-vehicle terminal, or the like. This is not limited thereto. The terminal device 400 and the server 200 may be directly or indirectly connected in a manner of wired or wireless communication. This is not limited in the embodiments of the present disclosure.

In some embodiments, the terminal device may implement the information recommendation method provided in the embodiments of the present disclosure by running various computer-executable instructions or a computer program. For example, the computer-executable instructions may be a microprogram-level command, machine instructions, or software instructions. The computer program may be a native program or a software module in an operating system; may be a native application (APP), namely, a program that needs to be installed in an operating system to run, such as an information reading APP, a video playing APP, an audio playing APP and a browser; or may be a mini program, namely, a program that only needs to be downloaded into a browser environment to run. In conclusion, the foregoing computer-executable instructions may be instructions in any form, and the foregoing computer programs may be an application, a module, or a plug-in in any form.

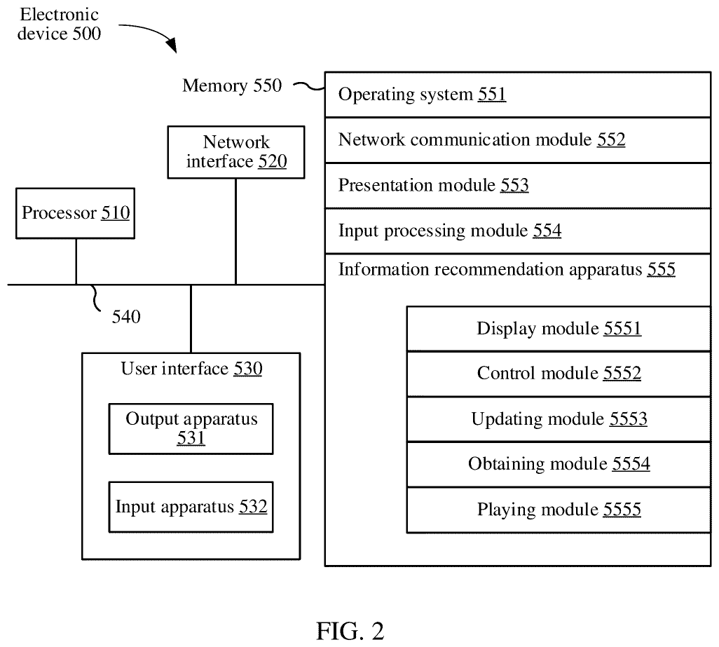

A structure of the electronic device provided in the embodiments of the present disclosure is described below. An example is used in which the electronic device is a terminal device. FIG. 2 is a schematic diagram of a structure of an electronic device 500 according to an embodiment of the present disclosure. The electronic device 500 shown in FIG. 2 includes: at least one processor 510, a memory 550, at least one network interface 520, and a user interface 530. All components in the electronic device 500 are coupled together by using a bus system 540. The bus system 540 is configured to implement connection and communication between the components. In addition to a data bus, the bus system 540 also includes a power supply bus, a control bus, and a status signal bus. However, for ease of clear description, all types of buses in FIG. 2 are denoted as the bus system 540.

The processor 510 may be an integrated circuit chip with a signal processing capability, for example, a general-purpose processor, a digital signal processor (DSP), another programmable logic device, a discrete gate or a transistor logic device, or a discrete hardware component. The general-purpose processor may be a microprocessor, any conventional processor, or the like.

The user interface 530 includes one or more output apparatuses 531 that enable presentation of media content, including one or more speakers and/or one or more visual display screens. The user interface 530 also includes one or more input apparatuses 532, including a user interface component that facilitates user input, for example, a keyboard, a mouse, a microphone, a touch display screen, a camera, or another input button and control.

The memory 550 may be a removable memory, a non-removable memory, or a combination thereof. An exemplary hardware device includes a solid-state memory, a hard disk drive, an optical disk drive, or the like. In some embodiments, the memory 550 includes one or more storage devices at a physical location away from the processor 510.

The memory 550 includes a volatile memory or a non-volatile memory, or may include both a volatile memory and a non-volatile memory. The non-volatile memory may be a read only memory (ROM). The volatile memory may be a random access memory (RAM). The memory 550 described in the embodiments of the present disclosure is intended to include any suitable type of memory.

In some embodiments, the memory 550 can store data to support various operations. Examples of the data include a program, a module, and a data structure or a subset or a superset thereof. An exemplary description is given below.

An operating system 551 includes system programs configured for processing various basic system services and executing hardware-related tasks, such as a framework layer, a kernel library layer, and a driver layer, and is configured for implementing various basic services and processing hardware-based tasks.

A network communication module 552 is configured to reach another computing device through one or more (wired or wireless) network interfaces 520. An exemplary network interface 520 includes: Bluetooth, wireless compatible authentication (Wi-Fi), a universal serial bus (USB), or the like.

A presentation module 553 is configured to enable presentation of information via one or more output apparatuses 531 (for example, a display and a speaker) associated with the user interface 530 (for example, a user interface for operating a peripheral device and displaying content and information).

An input processing module 554 is configured to detect one or more user inputs or interactions from one of the one or more input apparatuses 532 and translate the detected inputs or interactions.

In some embodiments, the apparatus provided in the embodiments of the present disclosure may be implemented by software. FIG. 2 shows an information recommendation apparatus 555 stored in the memory 550, which may be software in a form of a program, a plug-in or the like, and includes the following software modules: a display module 5551, a control module 5552, an updating module 5553, an obtaining module 5554, and a playing module 5555. The modules are logical and may be combined in different manners or further split based on to-be-implemented functions. In FIG. 2, for ease of description, all the foregoing modules are shown at one time. However, it is not to be considered that the information recommendation apparatus 555 eliminates the implementation that only the display module 5551 and the control module 5552 may be included. Functions of the modules are described below.

The information recommendation method provided in the embodiments of the present disclosure is described in detail below in combination with exemplary application and implementation of the terminal device provided in embodiments of the present disclosure.

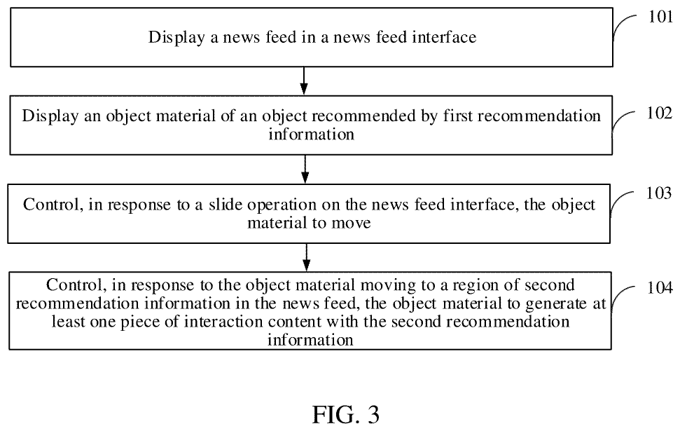

FIG. 3 is a schematic flowchart of an information recommendation method according to an embodiment of the present disclosure. Descriptions are provided with reference to operations shown in FIG. 3.

The method shown in FIG. 3 may be performed by various forms of computer programs run by the terminal device, not limited to a client, and for example, may alternatively be the foregoing operating system, the software module, the script, and the mini program described above. Therefore, the following examples of the client are not to be considered as a limitation on the embodiments of the present disclosure. In addition, for ease of description, the terminal device and the client run on the terminal device are not specifically distinguished in the following.

Operation 101: Display a news feed in a news feed interface.

First recommendation information may be inserted into the news feed. For example, the first recommendation information is a focus map advertisement. The focus map advertisement may be inserted into the top or the middle of the news feed.

In some embodiments, an example in which the client is a video playing client is used. The video playing client may be run on a terminal device associated with a user. When a tapping operation performed by the user on an icon of the video playing client is received, the video playing client may be started, to display the news feed interface on a screen of the terminal device, and display the news feed in the news feed interface. For example, a video stream arranged according to updating time may be displayed in the news feed interface. The first recommendation information (for example, a focus map advertisement) may be inserted into the video stream. For example, the focus map advertisement may be inserted into the top of the video stream. In other words, when entering a home page of the video playing client, the user may see a focus map advertisement on the top of the screen, for example, a focus map advertisement configured for recommending a handbag.

In addition to the focus map advertisement, the first recommendation information may further be an advertisement of another type, for example, a bumper advertisement, a button advertisement, or a landscape-mode advertisement. In addition, in addition to the top of the news feed, the first recommendation information may be further inserted into any location of the news feed. For example, the focus map advertisement may be inserted into the middle of the news feed. In other words, the user may see the focus map advertisement in a process of browsing the news feed. This is not specifically limited in the embodiments of the present disclosure.

Operation 102: Display an object material of an object recommended by the first recommendation information.

In some embodiments, operation 102 may be implemented in the following manner: displaying the object material of the object recommended by the first recommendation information in a manner of covering at least a part of the first recommendation information.

Exemplarily, the first recommendation information is the focus map advertisement. When display duration of the focus map advertisement reaches (greater than or equal to) a duration threshold (for example, 5 seconds) or a slide operation (for example, an upward slide operation) triggered by the user on the news feed is received, an object material (for example, a handbag material) of an object (for example, a handbag) recommended by the focus map advertisement may be displayed in a manner of covering at least a part of a region of the focus map advertisement. For example, after the focus map advertisement is displayed on the news feed interface for several seconds, the handbag material may be displayed at a location of the focus map advertisement in the manner of covering at least a part of the region of the focus map advertisement, for example, playing a frame-breaking animation video including the handbag material.

In some other embodiments, operation 102 may alternatively be implemented in the following manner: displaying, in response to display duration of the first recommendation information reaching a duration threshold (for example, 5 seconds), the object material of the object recommended by the first recommendation information, and displaying an atmosphere material related to the object material around the object material.

Exemplarily, the first recommendation information is the focus map advertisement. Assuming that an object recommended by the focus map advertisement is a handbag, when it is detected that display duration of the focus map advertisement is greater than 5 seconds, a handbag material may be displayed in a manner of covering at least a part of a region of the focus map advertisement, and an atmosphere material related to the handbag material is displayed around (for example, behind) the handbag material. The atmosphere material may be extracted from the handbag material. For example, the atmosphere material may be a dotted material extracted from the handbag material. In this way, a display effect may be further improved by simultaneously displaying the object material and the atmosphere material, thereby improving user experience.

In some embodiments, operation 102 may alternatively be implemented in the following manner: controlling the object material to appear at an edge of the region of the first recommendation information, and controlling the object material to move outward the region of the first recommendation information.

Exemplarily, the first recommendation information is the focus map advertisement. Assuming that an object recommended by the focus map advertisement is a car, when it is detected that display duration of the focus map advertisement reaches a duration threshold or a slide operation triggered by the user on the news feed is received, a car material may be controlled to appear from an edge (for example, a lower left corner) of a region of the focus map advertisement, and the car material is controlled to move outward the region of the focus map advertisement. For example, the car material may be controlled to appear from the lower left corner of the region of the focus map advertisement, and an animation effect that the car material is drifting appears on the news feed interface.

In some embodiments, the first recommendation information may include a plurality of images for recommending the object material, and the first recommendation information is displayed by playing the plurality of images in turn. The playing of the plurality of images in turn may also be stopped before the object material of the object recommended by the first recommendation information is displayed; and in response to satisfying a set condition, the playing the plurality of images in turn is restored. The set condition includes at least one of the following: the object material moving to a region of second recommendation information inserted into the news feed, receiving a trigger closing operation on the object material, or display duration of the object material reaching a duration threshold.

Exemplarily, the first recommendation information is the focus map advertisement. Assuming that an object recommended by the focus map advertisement is a handbag, playing of the plurality of images included in the focus map advertisement in turn may be stopped before a handbag material is displayed in the news feed interface, that is, only one of the plurality of images is currently displayed, and the user cannot switch to view another image by tapping or sliding. When it is detected that the handbag material moves to the region of the second recommendation information (for example, an initial news feed advertisement) inserted into the news feed, the trigger closing operation performed by the user on the handbag material is received (for example, a tapping operation performed by the user on a close button is received), or the display duration of the handbag material reaches the duration threshold, the playing of the plurality of images in turn may be restored. For example, automatic playing of the plurality of images in turn may be restored. In this way, during display of the object material, the user may focus on the object material by stopping playing the plurality of images in turn, thereby improving attractiveness of the object material and further increasing a conversion rate of the advertisement.

In some other embodiments, still using the foregoing example, the following processing may be further performed: shielding, before the object material of the object recommended by the first recommendation information is displayed, response to a trigger operation on the news feed; and restoring, in response to satisfying the foregoing set condition, response to the trigger operation on the news feed.

Exemplarily, the first recommendation information is the focus map advertisement. Assuming that an object recommended by the focus map advertisement is a handbag, before a handbag material is displayed, response to the trigger operation on the news feed may be shielded. In other words, during display of the handbag material, information (for example, a video and an article) in the news feed is in a state unavailable for tapping. When it is detected that the handbag material moves to the region of the second recommendation information (for example, the initial news feed advertisement) inserted into the news feed, the trigger closing operation performed by the user on the handbag material is received, or the display duration of the handbag material reaches the duration threshold, the trigger operation responding to the news feed may be restored, in other words, the information in the news feed can be currently tapped. In this way, during display of the object material, response to the trigger operation responding to the news feed is shielded, so that the user focuses on the object material, thereby improving attractiveness of the object material and further increasing a conversion rate of the advertisement.

In some embodiments, the first recommendation information may be located at a first location of the news feed, and the second recommendation information may be located at a second location of the news feed. In this case, operation 102 may alternatively be implemented in the following manner: playing a video including the object material of the object recommended by the first recommendation information, where duration of the video is consistent with duration for which the news feed moves from the first location to the second location.

Exemplarily, the first recommendation information is the focus map advertisement. Assuming that an object recommended by the focus map advertisement is a handbag, a location of the focus map advertisement in the news feed may be denoted as s0 and a location of the initial news feed advertisement (namely, the second recommendation information) in the news feed may be denoted as s1. When it is detected that the display duration of the focus map advertisement reaches the duration threshold, a video (namely, a frame-breaking animation video) including a handbag material may be played. Duration of the frame-breaking animation video is consistent with duration for which the news feed moves from the location s0 to the location s1. For example, when the handbag material moves from a region (corresponding to the location s0) of the focus map advertisement to a region (corresponding to the location s1) of the initial news feed advertisement, playing of the frame-breaking animation video ends, thereby improving user experience.

Operation 103: Control, in response to a slide operation on the news feed interface, the object material to move.

In some embodiments, operation 103 may be implemented in the following manner: keeping, in response to the slide operation on the news feed interface, the news feed still in the news feed interface, and controlling the object material and the atmosphere material to move toward a direction close to a first end (for example, a top end or a bottom end of the screen) of the news feed interface. To be specific, when the first recommendation information (for example, the focus map advertisement) and the second recommendation information (for example, the initial news feed advertisement) are located on the same screen, when the slide operation triggered by the user on the news feed interface is received, the news feed may be kept still in the news feed interface, and the object material and the atmosphere material are controlled to move from the region of the focus map advertisement to the region of the initial news feed advertisement.

The atmosphere material may be default. To be specific, when there is only the object material, the news feed in the news feed interface may be kept still, and the object material is controlled to move in the direction close to the first end of the news feed interface. For example, when the slide operation triggered by the user on the news feed interface is received, the object material may be controlled to drop downward. This is not specifically limited in the embodiments of the present disclosure.

In addition, the object material may move at a constant speed in the news feed interface, or may move at a variable speed. In addition, a moving track of the object material may be a straight line, or may be a curve. For example, the object material may move along any set curve. This is not specifically limited in the embodiments of the present disclosure.

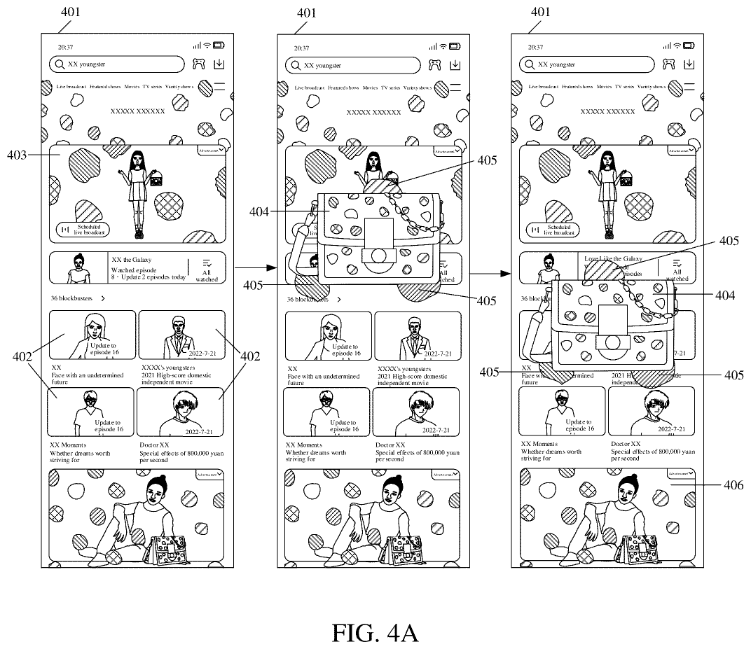

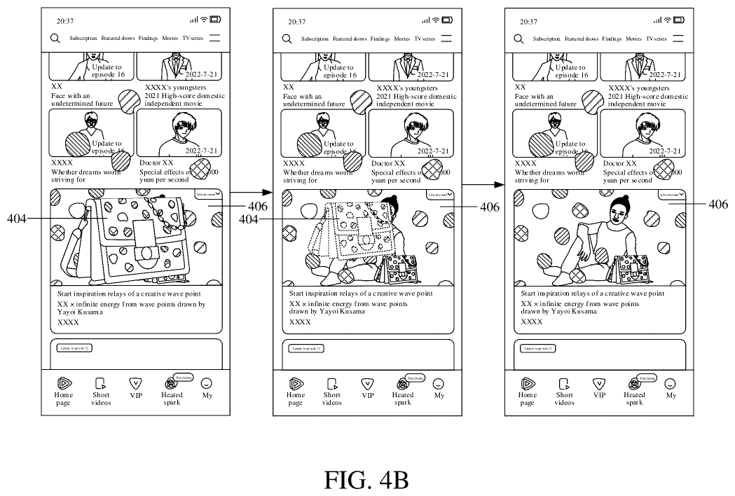

Exemplarily, FIG. 4A is a schematic diagram of an application scenario of an information recommendation method according to an embodiment of the present disclosure. As shown in FIG. 4A, a news feed 402 (for example, a video stream) is displayed on a news feed interface 401 and a focus map advertisement 403 (namely, the first recommendation information) is inserted into the top of the news feed 402. In this case, the focus map advertisement 403 may be configured for recommending a handbag. When it is detected that display duration of the focus map advertisement 403 reaches 5 seconds or an upward slide operation triggered by a user on the news feed interface 401 is received, a handbag material 404 of the handbag recommended by the focus map advertisement 403 may be displayed in a manner of covering at least a part of a region of the focus map advertisement 403, and a related atmosphere material 405 is displayed behind the handbag material 404. Subsequently, the news feed 402 may be kept still in the news feed interface 401, and the handbag material 404 and the atmosphere material 405 are controlled to drop downward. When the handbag material 404 and the atmosphere material 405 drop into a region of an initial news feed advertisement 406 (namely, the second recommendation information) in the news feed 402, the handbag material 404 and the atmosphere material 405 may be controlled to stay in the region of the initial news feed advertisement 406, that is, the handbag material 404 and the atmosphere material 405 are controlled to stop dropping.

In some embodiments, operation 103 may alternatively be implemented in the following manner: keeping, in response to the slide operation on the news feed interface, the news feed still in the news feed interface, and controlling the object material to move in a slide direction of the slide operation or a reverse direction of the slide direction. In some implementations, “a reverse direction of the slide direction” may refer to “an opposite direction of the slide direction.”

Exemplarily, the first recommendation information is the focus map advertisement. Assuming that an object recommended by the focus map advertisement is a handbag, when it is detected that display duration of the focus map advertisement reaches a duration threshold (for example, 5 seconds), a handbag material and an atmosphere material related to the handbag material may be displayed in a manner of covering at least a part of the region of the focus map advertisement. Next, when the slide operation (for example, an upward slide operation) triggered by the user on the news feed interface is received, the news feed may be kept still in the news feed interface, and the object material and the atmosphere material are controlled to move in the slide direction (namely, an upward direction) or a reverse direction of the slide direction (namely, a downward direction).

In some other embodiments, the object material and the atmosphere material may alternatively be kept still in the news feed interface, and the object material and the atmosphere material reach the region of the second recommendation information in a manner of moving the news feed. The following processing may alternatively be performed: keeping, in response to the slide operation on the news feed interface, the object material and the atmosphere material still, and controlling the news feed in the news feed interface to move in the slide direction of the slide operation. In other words, when the first recommendation information (for example, the focus map advertisement) and the second recommendation information (for example, the initial news feed advertisement) are not located on the same screen, when the slide operation triggered by the user on the news feed interface is received, the object material and the atmosphere material may be kept still, and the news feed is controlled in the news feed interface to move in the slide direction of the slide operation triggered by the user, so that the object material and the atmosphere material reach the region of the second recommendation information in the news feed.

The foregoing atmosphere material may be default. To be specific, when there is only the object material, the object material may be kept still in the news feed interface and the news feed may be controlled to move in the slide direction of the slide operation triggered by the user on the news feed interface. For example, assuming that the slide direction of the slide operation triggered by the user is the upward direction, the object material may be kept still in the news feed interface and the news feed may be controlled to move upward. This is not specifically limited in the embodiments of the present disclosure.

Exemplarily, the first recommendation information is the focus map advertisement. Assuming that an object recommended by the focus map advertisement is a handbag, when an upward slide operation triggered by the user on the news feed interface is received, a handbag material and an atmosphere material related to the handbag material may be displayed in a manner of covering at least a part of the region of the focus map advertisement. Next, the handbag material and the atmosphere material may be kept still, and the news feed in the news feed interface is controlled to move upward. When it is detected that the handbag material and the atmosphere material reach the region of the initial news feed advertisement (namely, the second recommendation information) in the news feed, the handbag material and the atmosphere material may be controlled to stay in the region of the initial news feed advertisement.

In some embodiments, operation 103 may alternatively be implemented in the following manner: controlling, in response to the slide operation on the news feed interface, the news feed in the news feed interface to move in the slide direction of the slide operation, and controlling the object material and the atmosphere material to move in the reverse direction of the slide direction. To be specific, when the first recommendation information (for example, the focus map advertisement) and the second recommendation information (for example, the initial news feed advertisement in the news feed) are not located on the same screen, when the news feed is controlled to move in the slide direction of the slide operation triggered by the user, the object material and the atmosphere material may also be simultaneously controlled to move to the reverse direction of the slide direction, thereby more quickly controlling the object material and the atmosphere material to reach the region of the second recommendation information in the news feed. In some implementations, “a reverse direction of the slide direction” may refer to “an opposite direction of the slide direction.”

The foregoing atmosphere material may be default. To be specific, when there is only the object material, the news feed in the news feed interface is controlled to move in the slide direction of the slide operation triggered by the user and simultaneously the object material may also be controlled to move in the reverse direction of the slide direction. For example, when the slide direction is the upward direction, when the news feed is controlled to move upward, the object material may also be controlled to move downward (for example, drop downward). This is not specifically limited in the embodiments of the present disclosure.

Exemplarily, the first recommendation information is the focus map advertisement. Assuming that an object recommended by the focus map advertisement is a handbag. When an upward slide operation triggered by the user on the news feed interface is received, a handbag material and an atmosphere material related to the handbag material may be displayed in the manner of covering at least a part of the region of the focus map advertisement. Next, the news feed (for example, a video stream) in the news feed interface may be controlled to move upward, and the handbag material and the atmosphere material may also be controlled to move downward. In this way, the handbag material and the atmosphere material can reach the region of the initial news feed advertisement in the news feed more quickly.

In some embodiments, in the process of controlling movement of the object material, the following processing may be also performed: updating a display perspective of the object material, to display a front view of the object material in the news feed interface.

Exemplarily, the object recommended by the first recommendation information is a vehicle. In a process of controlling a vehicle material to move in the news feed interface, a display perspective of the vehicle material may also be updated, to display a front view of the vehicle material in the news feed interface. For example, in a process of controlling the vehicle material to move relative to the news feed, the display perspective of the vehicle material may be switched from a top-view display perspective to a front-view display perspective, that is, switched from a top view displaying the vehicle material to a front view displaying the vehicle material. In this way, it is convenient for the user to observe the object recommended by the first recommendation information from different angles, thereby improving user experience.

In some other embodiments, in the process of controlling the object material to move in the news feed interface, the following processing may also be performed: controlling the news feed to be in tilt due to an impact of the object material.

Exemplarily, the controlling the news feed to be in tilt due to an impact of the object material may be implemented in the following manner: obtaining a configuration parameter preset for the news feed, where the configuration parameter includes: a time function, a Bezier curve parameter, and a transform matrix. When the news feed receives the impact of the object material, an animation in which the news feed is in tilt is played based on the configuration parameter. The time function is configured for controlling duration of the animation, the Bezier curve parameter is configured for controlling presentation of the animation, and the transform matrix is configured for controlling a degree of the tilt. In this way, the news feed is in tilt, so that attention of the user may be further attracted, thereby increasing a conversion rate of the advertisement.

Exemplarily, the first recommendation information is the focus map advertisement. Assuming that an object recommended by the focus map advertisement is a vehicle (for example, a car), in the process of controlling the vehicle material to move relative to the news feed, the following processing may be also performed: obtaining a configuration parameter preset for the news feed, where the configuration parameter may include: a time function, a Bezier curve parameter (assumed to be denoted as b), and a transform matrix (assumed to be denoted as m). When the news feed receives an impact of the vehicle material, for example, the vehicle material may be controlled to appear from a right side of the screen and the news feed is impacted, in this case, an animation in which the news feed is in tilt to the left may be played based on the obtained configuration parameter. Duration of the animation may be controlled by using the time function in the configuration parameter, a presentation process of the animation may be controlled by using the Bezier curve parameter in the configuration parameter, and a degree of tilt to the left in the news feed may be controlled by using the transform matrix in the configuration parameter. In other words, planners may set the configuration parameter to control a news feed tilt process.

In some embodiments, still using the foregoing example, after the object material is controlled to move to the region of the second recommendation information in the news feed, the following processing may be further performed: controlling the news feed to restore from a tilt state to an initial state, where the initial state is a state in which the news feed is displayed in the news feed interface in a straight manner.

Exemplarily, the second recommendation information is the initial news feed advertisement in the news feed. When it is detected that the object material (for example, the vehicle material) reaches the region of the initial news feed advertisement in the news feed, the news feed may be controlled to be restored from the tilt state to the initial state. For example, an animation in which the news feed shakes to restore from the tilt state may be played. In this way, it is convenient for the user to subsequently perform an operation on the information in the news feed. For example, it is convenient for the user to subsequently view the information in the news feed or tap the information in the news feed.

Operation 104: Control, in response to the object material moving to the region of the second recommendation information in the news feed, the object material to generate at least one piece of interaction content with the second recommendation information.

The object recommended by the second recommendation information and the object recommended by the first recommendation information may be the same. For example, the first recommendation information is the focus map advertisement, and the second recommendation information is the initial news feed advertisement in the news feed. Both the focus map advertisement and the initial news feed advertisement may be car advertisements.

In some other embodiments, the object recommended by the second recommendation information and the object recommended by the first recommendation information may alternatively be similar. The similarity herein means that a similarity between the object recommended by the second recommendation information and the object recommended by the first recommendation information is greater than a similarity threshold. For example, the object recommended by the second recommendation information is a car with a model A produced by a car company and the object recommended by the first recommendation information is a car with a model B produced by the same car company. Alternatively, the object recommended by the second recommendation information is a car A produced by a car company A and the object recommended by the second recommendation information is a car B with the same model produced by a car company B. This is not specifically limited in the embodiments of the present disclosure.

During actual application, whether the object recommended by the second recommendation information and the object recommended by the first recommendation information are similar may further be determined with reference to an artificial intelligence (AI) technology. For example, feature extraction may be separately performed on the object recommended by the second recommendation information and the object recommended by the first recommendation information, to correspondingly obtain an object feature of the object recommended by the second recommendation information and an object feature of the object recommended by the first recommendation information. Next, a similarity (for example, including a cosine similarity and a Euclidean distance) between the object feature of the object recommended by the second recommendation information and the object feature of the object recommended by the first recommendation information may be calculated. When the similarity is greater than the similarity threshold, it indicates that the object recommended by the second recommendation information and the object recommended by the first recommendation information are similar.

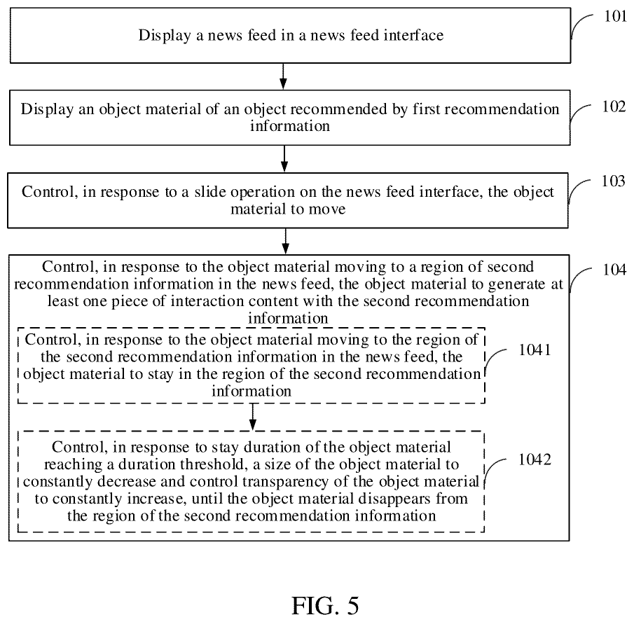

In some embodiments, FIG. 5 is a schematic flowchart of an information recommendation method according to an embodiment of the present disclosure. As shown in FIG. 5, operation 104 shown in FIG. 3 may be implemented by performing operation 1041 and operation 1042 shown in FIG. 5, and is described with reference to operations shown in FIG. 5.

Operation 1041: Control, in response to the object material moving to the region of the second recommendation information in the news feed, the object material to stay in the region of the second recommendation information.

Exemplarily, the first recommendation information is the focus map advertisement, and the second recommendation information is the initial news feed advertisement in the news feed. Assuming that an object recommended by the focus map advertisement is a handbag, when it is detected that the handbag material moves to the region of the initial news feed advertisement in the news feed, the handbag material may be controlled to stay in the region of the initial news feed advertisement, that is, when it is detected that the handbag material moves to the region of the initial news feed advertisement in the news feed, the handbag material may be controlled to stop moving.

Operation 1042: Control, in response to stay duration of the object material reaching a duration threshold, a size of the object material to constantly decrease, and control transparency of the object material to constantly increase, until the object material disappears from the region of the second recommendation information.

Exemplarily, the first recommendation information is the focus map advertisement and the second recommendation information is the initial news feed advertisement in the news feed. Assuming that an object recommended by the focus map advertisement is a handbag, when it is detected that duration for which the handbag material stays in the region of the initial news feed advertisement in the news feed reaches the duration threshold (for example, 4 seconds), a size of the handbag material may be controlled to constantly decrease, and transparency of the handbag material may also be controlled to constantly increase (to be specific, the handbag material is controlled to constantly become transparent), until the handbag material disappears from the region of the initial news feed advertisement. In this way, by controlling the size of the handbag material to constantly decrease and controlling the handbag material to gradually disappear, attention of the user may be attracted, thereby increasing a conversion rate of the advertisement.

For example, the object recommended by first recommendation information is a handbag, and the second recommendation information is the initial news feed advertisement in the news feed. FIG. 4B is a schematic diagram of an application scenario of an information recommendation method according to an embodiment of the present disclosure. As shown in FIG. 4B, when it is detected that duration for which the handbag material 404 stays in the region of the initial news feed advertisement 406 in the news feed is greater than 4 seconds, a size of the handbag material 404 may be controlled to constantly decrease, and transparency of the handbag material 404 may be controlled to constantly increase, until the handbag material 404 disappears from the region of the initial news feed advertisement 406. At this moment, a correlation process between the focus map advertisement and the initial news feed advertisement ends.

In some other embodiments, the controlling the object material to generate at least one piece of interaction content with the second recommendation information may alternatively be implemented in the following manner: controlling the object material to move in the region of the second recommendation information, where when the object material moves to an edge of the region of the second recommendation information, the object material is controlled to move in a reverse direction.

Exemplarily, the first recommendation information is the focus map advertisement, and the second recommendation information is the initial news feed advertisement in the news feed. Assuming that an object recommended by the focus map advertisement is a handbag, after the handbag material is controlled to stay in the region of the initial news feed advertisement in the news feed, the handbag material may be further controlled to move in the region of the initial news feed advertisement. When the handbag material moves to an edge of the region of the initial news feed advertisement, the handbag material may be controlled to move in a reverse direction. In this way, an interesting foreground picture may be formed in the region of the initial news feed advertisement, to attract attention of the user, thereby increasing a conversion rate of the advertisement.

After the object material is controlled to reach the region of the second recommendation information in the news feed, the size of the object material may be further adjusted (for example, the size of the object material is increased), and the object material whose size is adjusted is controlled to move to a target location in the second recommendation information, and is displayed in a hover box nearby the target location, to generate the interaction content. The target location may be a location at which the object material of the object recommended by the second recommendation information is located, a location at which a hand of a model included in the second recommendation information is located, a central location of the region of the second recommendation information, a selected location by the user in the region of the second recommendation information, or the like. In other words, after the object material is controlled to move to the region of the second recommendation information in the news feed, the object material and the second recommendation information may be fused, to obtain the fused second recommendation information (namely, the interaction content). In this way, attractiveness of the recommendation information may be further improved, thereby increasing a conversion rate of the recommendation information.

In some embodiments, the controlling the object material to generate at least one piece of interaction content with the second recommendation information may alternatively be implemented in the following manner: performing a copy operation on the object material, to obtain a plurality of object materials; controlling the plurality of object materials to move in the region of the second recommendation information; and jumping, in response to a trigger operation on any one of the object materials, from the news feed interface to an association interface associated with the object material. In some implementations, “jumping” from the news feed interface to an association interface associated with the object material may refer to as “switching” from the news feed interface to an association interface associated with the object material. In some implementations, the trigger operation may include at least one of a click, a slide, or a touch gesture from a user.

Exemplarily, the object recommended by the first recommendation information is a handbag. After the handbag material is controlled to move to the region of the initial news feed advertisement (namely, the second recommendation information) in the news feed, a copy operation may be performed on the handbag material, to obtain a plurality of handbag materials (for example, five handbag materials). Then, the plurality of handbag materials may be controlled to move up and down in the region of the initial news feed advertisement, to form an interesting foreground picture. Subsequently, when the user is interested in the handbag, the user may tap any one of the handbag materials. For example, when a tapping operation performed by the user on any handbag material of the plurality of handbag materials is received, the news feed interface may be jumped to an advertisement landing page for purchasing the handbag, thereby facilitating purchasing by the user.

To be specific, the foregoing interaction content may be that the object material is controlled to stay in the region of the second recommendation information, may also be that the object material is controlled to move in the region of the second recommendation information, or may be that the size of the object material is adjusted and then the object material whose size is adjusted is controlled to move in the region of the second recommendation information. A form of the interaction content is not specifically limited in the embodiments of the present disclosure.

In some other embodiments, the following processing may also be performed: jumping, in response to the trigger operation on the first recommendation information or the second recommendation information, from the news feed interface to the association interface (for example, the advertisement landing page) associated with the object material.

Exemplarily, the first recommendation information is the focus map advertisement, and the second recommendation information is the initial news feed advertisement in the news feeds. When the tapping operation performed by the user on the focus map advertisement or the initial news feed advertisement is received, a corresponding advertisement landing page may be jumped to from the news feed interface, thereby facilitating a subsequent process of purchasing a commodity by the user.

According to the information recommendation method provided in the embodiments of the present disclosure, an object material is presented in a larger area by means of correlating two pieces of recommendation information that are originally independent of each other, so that information about an object recommended by the first recommendation information can be presented more comprehensively in a larger range, attractiveness of the object material is improved, and an interaction effect and user experience of the recommendation information are also improved.

The following describes exemplary application of the embodiments of the present disclosure in an actual application scenario.

An embodiment of the present disclosure provides an information recommendation method. By correlating a focus map advertisement (corresponding to the foregoing first recommendation information) with a news feed advertisement (corresponding to the foregoing second recommendation information), art presentation and technology correlation are implemented to attract attention of a user, thereby increasing a conversion rate of an advertisement provided by an advertiser and improving user experience in an APP. A conventional focus map advertisement and news feed advertisement are usually limited by a region size, limiting presentation of content and product details of the advertiser, and consequently, user experience and brand attractiveness cannot be effectively improved. To resolve the problem, an embodiment of the present disclosure proposes that a focus map advertisement and a news feed advertisement are correlated by using a transition animation, to form an advertisement content presentation region larger than one screen, thereby expanding space for ideas of the advertiser. When a user is interested in the advertisement, the user may directly tap to enter an advertisement landing page or continue to use an APP after presentation of the transition animation ends.

To be specific, the conventional focus map advertisement and news feed advertisement generally have limitations in the presentation region, and cannot satisfy requirements of the advertiser for presenting content and product details, thereby limiting improvement of user experience and enhancement of brand attractiveness. To improve the situation, an embodiment of the present disclosure provides a solution of correlating the focus map advertisement with a news feed advertisement in which the correlative focus map advertisement and the news feed advertisement are connected by using a transition animation.

Exemplarily, in the technical solution provided in this embodiment of the present disclosure, the transition animation is set between the focus map advertisement and the news feed advertisement, so that the focus map advertisement and the news feed advertisement are connected head to tail during presentation, to form a continuously presented advertisement content region. By means of art presentation and technology correlation, attention of the user is attracted, and more presentation space is provided for the advertiser, so that ideas of the advertiser can be played better and more. The correlative presentation manner may provide a presentation region larger than one screen, to increase a presentation amount and enhance richness of advertisement content.

When the user is interested in a correlation process, the user may directly tap the focus map advertisement or the news feed advertisement, to enter a corresponding advertisement landing page, thereby increasing a conversion rate of the advertisement. In addition, if the user does not tap immediately, the user may continue to use the APP after presentation of the transition animation ends, thereby ensuring smooth experience of using the APP by the user.

In this embodiment of the present disclosure, by correlating the focus map advertisement with the news feed advertisement, with reference to art presentation and technology correlation of the transition animation, an advertisement content presentation region larger than one screen is implemented. The innovative presentation manner can attract attention of a user, thereby increasing a conversion rate of an advertisement provided by an advertiser, and improving user experience in an APP. The advertiser can present more content and product details by using large presentation space, thereby increasing brand exposure and product understanding of the user. In addition, when the user is interested in the correlation process, the user may directly tap to enter an advertisement landing page, thereby promoting generation of a purchase decision. The user who continues to use the APP after presentation of the transition animation ends can still keep in contact with the advertisement and obtain valuable information from the advertisement content.

In addition, to implement the foregoing solution of correlating the focus map advertisement with the news feed advertisement, an existing technology and device may be used in this embodiment of the present disclosure, for example, an interaction function of an APP development platform with a touchscreen mobile phone. By designing and implementing a transition animation between the focus map advertisement and the news feed advertisement, a smooth transition effect may be achieved and attention and participation of the user may be enhanced.

In conclusion, the solution of correlating the focus map advertisement with the news feed advertisement provided by the embodiments of the present disclosure may bring innovation and improvement to the advertisement industry. By means of art presentation and technology correlation, an advertisement content presentation region is expanded, user experience and brand attraction are improved, and a conversion rate of an advertisement provided by the advertiser is increased. The information recommendation method provided in the embodiments of the present disclosure may be widely applied to various APPs and advertisement platforms, and brings a win-win effect to the user and the advertiser.

The information recommendation method provided in the embodiments of the present disclosure is described in detail below.

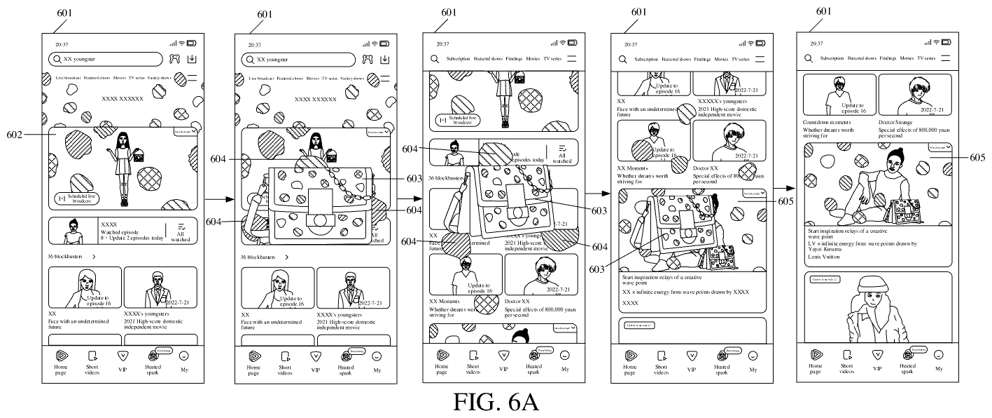

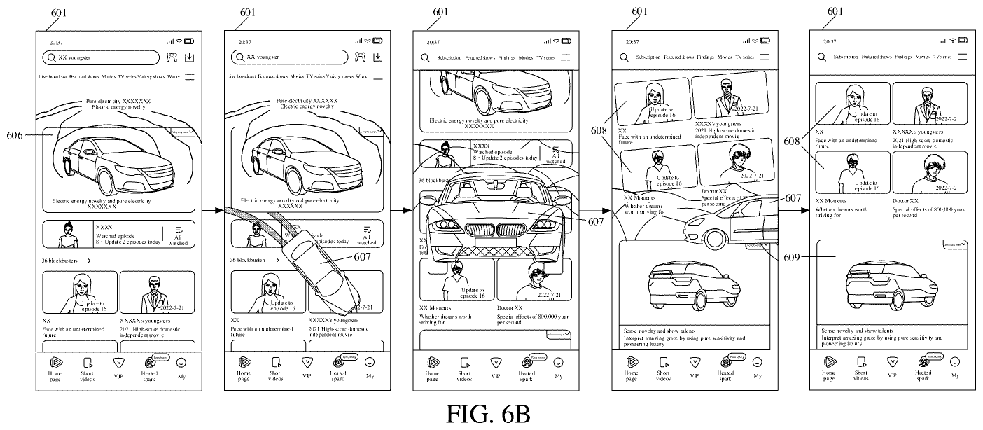

In some embodiments, FIG. 6A is a schematic diagram of an application scenario of an information recommendation method according to an embodiment of the present disclosure. As shown in FIG. 6A, after entering an APP home page 601 (corresponding to the foregoing news feed interface), a user may see a focus map advertisement 602. A frame-breaking product element 603 (corresponding to the foregoing object material, for example, the handbag material) and an atmosphere element 604 (corresponding to the foregoing atmosphere material, for example, the dotted material behind the handbag material) may appear after several seconds. The frame-breaking product element 603 and the atmosphere element 604 may drop downward, and a news feed on a screen may move upward. After the frame-breaking product element 603 drops into a region of an initial news feed advertisement 605 in the news feed, the frame-breaking product element 603 may be controlled to stop dropping, gradually zoom out, and fade out. At this moment, the correlation between the focus map advertisement and the initial news feed advertisement ends.

In some other embodiments, FIG. 6B is a schematic diagram of an application scenario of an information recommendation method according to an embodiment of the present disclosure. As shown in FIG. 6B, after entering the home page 601 of the APP, the user may see a focus map advertisement 606. A product (for example, a car) is presented in the focus map advertisement 606 together with an atmosphere wave element. A frame-breaking product element 607 (for example, a car material) may appear after several seconds, an animation effect that the frame-breaking product element 607 is drifting on the screen is presented, and at the same time, the news feed on the screen may move upward. Subsequently, a front view of the frame-breaking product element 607 (for example, the car material) may appear, and the news feed on the screen may continue to move upward. Then, the frame-breaking product element 607 may be controlled to appear on the right side of the screen, with an effect of impacting a news feed 608 to be skew, and the news feed on the screen may continue to move upward. Finally, after the frame-breaking product element 607 reaches a region of an initial news feed advertisement 609 in the news feed, the skew news feed 608 shakes to restoration. At this moment, the correlation between the focus map advertisement and the initial news feed advertisement ends.

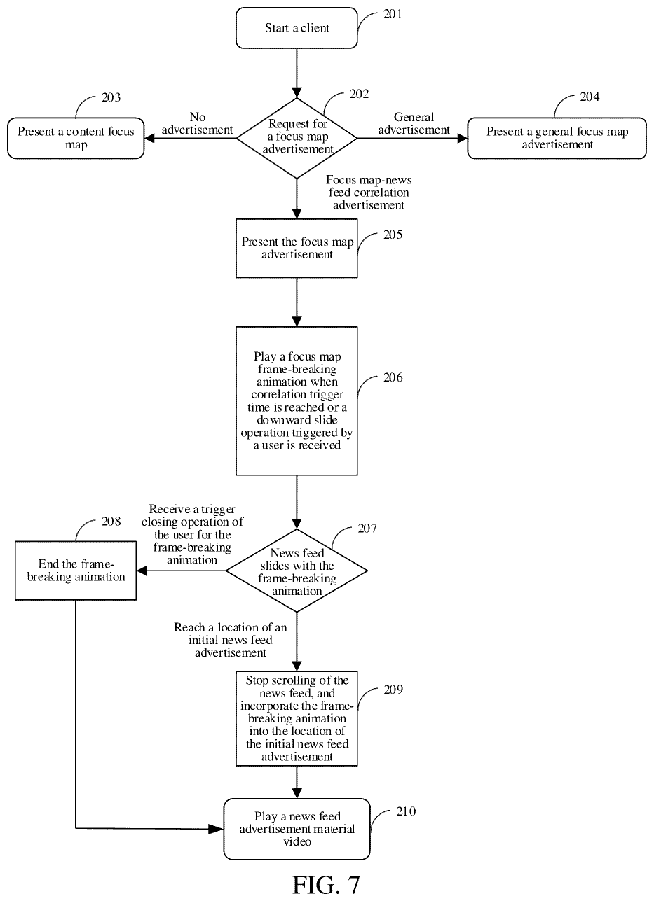

The information recommendation method provided in this embodiment of the present disclosure is described in detail below with reference to FIG. 7.

Exemplarily, FIG. 7 is a schematic flowchart of an information recommendation method according to an embodiment of the present disclosure. Descriptions are provided with reference to operations shown in FIG. 7.

Operation 201: Start a client.

Operation 202: Request for a focus map advertisement; and perform operation 203 if there is no focus map advertisement; perform operation 204 if the focus map advertisement is a general focus map advertisement; or perform operation 205 if the focus map advertisement is a focus map-news feed correlation advertisement.

Operation 203: Present a content focus map.

Operation 204: Present the general focus map advertisement.

Operation 205: Present the focus map advertisement.

Operation 206: Play a focus map frame-breaking animation when correlation trigger time is reached or a downward slide operation triggered by a user is received.

Operation 207: When a news feed slides with the frame-breaking animation, if a trigger closing operation performed by the user on the frame-breaking animation is received, perform operation 208; or if a location of an initial news feed advertisement is reached, perform operation 209.

Operation 208: End the frame-breaking animation.

Operation 209: Stop scrolling of the news feed, and incorporate the frame-breaking animation into the location of the initial news feed advertisement.

Operation 210: Play a news feed advertisement material video.

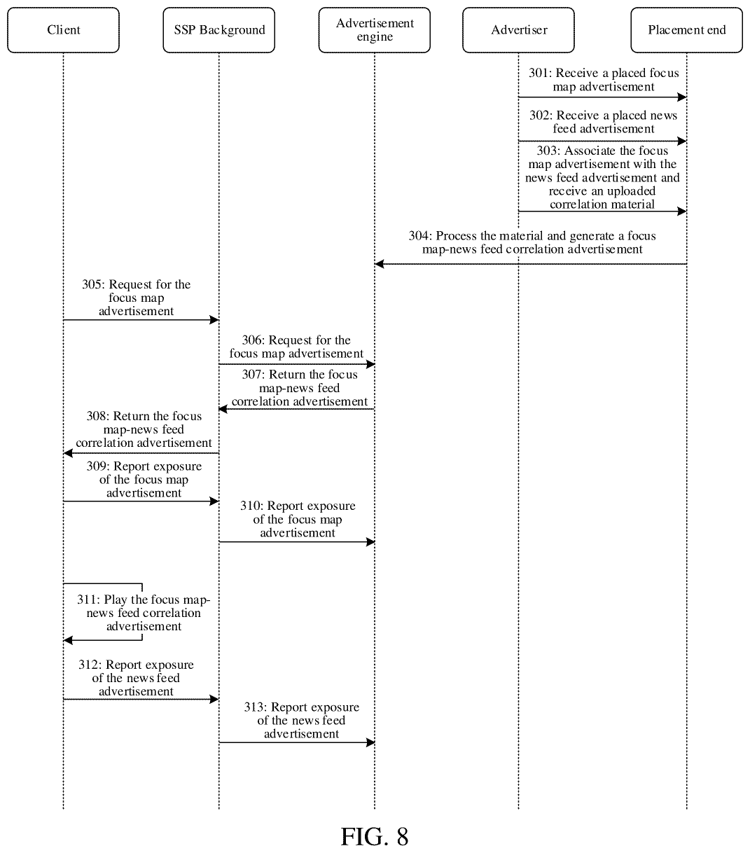

The information recommendation method provided in this embodiment of the present disclosure is described in detail below with reference to FIG. 8.

Exemplarily, FIG. 8 is a schematic flowchart of an information recommendation method according to an embodiment of the present disclosure. Descriptions are provided with reference to operations shown in FIG. 8.

Operation 301: A placement end receives a focus map advertisement placed by an advertiser.

Operation 302: The placement end receives a news feed advertisement placed by the advertiser.

Operation 303: The placement end associates the focus map advertisement with the news feed advertisement, and receives a correlation material uploaded by the advertiser.

Operation 304: The placement end processes the material in an advertisement engine, and generates a focus map-news feed correlation advertisement.

In some embodiments, an advertiser first needs to separately place a focus map advertisement and a news feed advertisement at a placement end, and then creates a focus map-news feed correlation advertisement. For example, a focus map advertisement and a news feed advertisement may be selected to be combined. In addition, the advertiser needs to additionally upload a frame-breaking animation video. The format may be a video format supporting a transparent channel, and is transcoded by the placement end into an MP4 format separating red green blue (RGB) and Alpha for a client to use.

Operation 305: The client requests an SSP background for the focus map advertisement.

In some embodiments, when the client requests the sell-side platform (SSP) background for the focus map advertisement, if there is an available focus map-news feed correlation advertisement, the placement end may additionally deliver news feed advertisement content, a frame-breaking animation video v1, interaction start time t1, and interaction end time t2 based on the general focus map advertisement. The interaction start time t1 is less than the interaction end time t2.

Operation 306: The SSP background requests an advertisement engine for the focus map advertisement.

Operation 307: The advertisement engine returns the focus map-news feed correlation advertisement to the SSP background.

Operation 308: The SSP background returns the focus map-news feed correlation advertisement to the client.

Operation 309: The client reports exposure of the focus map advertisement to the SSP background.

Operation 310: The SSP background reports the exposure of the focus map advertisement to the advertisement engine.

Operation 311: The client plays the focus map-news feed correlation advertisement.

In some embodiments, the client may first present the focus map advertisement, stop playing the focus map in turn, prohibit tapping on the news feed, and start to play a focus map advertisement material video. When the focus map advertisement material video is played to the time point t1 or a downward slide operation triggered by a user is received, a frame-breaking animation procedure starts. Playing of the focus map advertisement material video is stopped, and the frame-breaking animation video v1 (which is a frame-breaking animation for short) starts to be played. In this case, a news feed slide location may be denoted as s0, a location of an initial news feed advertisement in the news feed may be denoted as s1, duration of the frame-breaking animation video v1 may be denoted as duration, a sliding animation of the news feed starts to be played from s0 to s1, and duration of the sliding animation is also denoted as duration.

In some other embodiments, when the news feed slides to the location of the initial news feed advertisement, a tapping operation of the user on a close button is received, or playing duration of the frame-breaking animation video v1 exceeds the interaction end time t2, the frame-breaking animation procedure ends, the playing of the focus map in turn is restored, the tapping of the news feed is restored, and the initial news feed advertisement material video in the news feed starts to be played.

After tapping the focus map advertisement or the initial news feed advertisement, the user may enter an advertisement landing page, to enter a general advertisement process. In addition, in this embodiment of the present disclosure, based on the foregoing focus map-news feed correlation advertisement, configuration parameters of a news feed view animation may be additionally added, for example, including an animation start time t1, duration d, a time function, a Bezier curve parameter b, and a transform matrix m. The Bezier curve parameter b may be configured for controlling presentation of the animation, the transform matrix m may be configured for controlling a location offset, zooming-in, and zooming-out and the transform matrix m may support a standard 3D transform. In the frame-breaking animation procedure, in this embodiment of the present disclosure, an animation such as displacement, rotation, zoom, and tilt may be supported on the news feed view of the background.

Operation 312: The client reports exposure of the news feed advertisement to the SSP background.

Operation 313: The SSP background reports the exposure of the news feed advertisement to the advertisement engine.

Based on the above, the information recommendation method provided in this embodiment of the present disclosure has the following beneficial effects:
1) A user views a focus map advertisement and an initial news feed advertisement, so that the advertisement is more interesting and interactive, thereby improving user experience.
2) An advertisement material is presented in a larger area by expanding two original advertisement regions, so that product information is presented more comprehensively in a larger range, and attractiveness of a flash-screen advertisement material is improved.
3) An advertisement interaction effect is improved.

An exemplary structure of an information recommendation apparatus 555 provided in the embodiments of the present disclosure implemented as a software module is further described below. In some embodiments, as shown in FIG. 2, software module of the information recommendation apparatus 555 stored in the memory 550 may include: a display module 5551 and a control module 5552.

The display module 5551 is configured to display a news feed in a news feed interface, where first recommendation information is inserted into the news feed. The display module 5551 is further configured to display an object material of an object recommended by the first recommendation information. The control module 5552 is configured to control, in response to a slide operation on the news feed interface, the object material to move. The control module 5552 is further configured to control, in response to the object material moving to a region of second recommendation information in the news feed, the object material to generate at least one piece of interaction content with the second recommendation information. An object recommended by the second recommendation information is the same as or similar to the object recommended by the first recommendation information.

In some embodiments, the display module 5551 is further configured to display the object material of the object recommended by the first recommendation information in a manner of covering at least a part of the first recommendation information.

In some embodiments, the display module 5551 is further configured to display, in response to display duration of the first recommendation information reaching a duration threshold, the object material of the object recommended by the first recommendation information, and display an atmosphere material related to the object material around the object material.

In some embodiments, the control module 5552 is further configured to keep, in response to a slide operation on the news feed interface, the news feed still in the news feed interface, and control the object material to move in a slide direction of the slide operation or a reverse direction of the slide direction.

In some embodiments, the control module 5552 is further configured to control, in response to the slide operation on the news feed interface, the news feed in the news feed interface to move in the slide direction of the slide operation, and control the object material and the atmosphere material to move in the reverse direction of the slide direction.

In some embodiments, the control module 5552 is further configured to control the object material to be displayed in a hover box at a target location in the region of the second recommendation information, where the target location includes one of the following: a central location in the region of the second recommendation information or a selected location in the region of the second recommendation information.

In some embodiments, the control module 5552 is further configured to control the object material to stay in the region of the second recommendation information, control, in response to stay duration of the object material reaching a duration threshold, a size of the object material to constantly decrease, and control transparency of the object material to constantly increase, until the object material disappears from the region of the second recommendation information.

In some embodiments, the control module 5552 is further configured to control the object material to move in the region of the second recommendation information, where when the object material moves to an edge of the region of the second recommendation information, the object material is controlled to move in a reverse direction.

In some embodiments, the control module 5552 is further configured to control the object material to appear at an edge of the region of the first recommendation information, and control the object material to move outward the region of the first recommendation information.

In some embodiments, the information recommendation apparatus 555 also includes an updating module 5553. The updating module 5553 is configured to update, in the process of controlling movement of the object material, a display perspective of the object material, to display a front view of the object material in the news feed interface.

In some embodiments, the control module 5552 is further configured to control, in the process of controlling the object material to move, the news feed to be in tilt due to an impact of the object material.

In some embodiments, the information recommendation apparatus 555 also includes an obtaining module 5554 and a playing module 5555. The obtaining module 5554 is configured to obtain a configuration parameter preset for the news feed, where the configuration parameter includes: a time function, a Bezier curve parameter, and a transform matrix. The playing module 5555 is configured to play, when the news feed receives the impact of the object material, an animation in which the news feed is in tilt based on the configuration parameter. The time function is configured for controlling duration of the animation, the Bezier curve parameter is configured for controlling presentation of the animation, and the transform matrix is configured for controlling a degree of the tilt.

In some embodiments, the control module 5552 is further configured to control the news feed to restore from a tilt state to an initial state, where the initial state is a state in which the news feed is displayed in the news feed interface in a straight manner.

In some embodiments, the control module 5552 is further configured to jump, in response to a trigger operation on the first recommendation information the second recommendation information, from the news feed interface to an association interface associated with the object material. In some implementations, the trigger operation may include at least one of a click, a slide, or a touch gesture from a user.

In some embodiments, the first recommendation information includes a plurality of images for recommending the object material, and the first recommendation information is displayed by playing the plurality of images in turn. The control module 5552 is further configured to stop, before the object material of the object recommended by the first recommendation information is displayed, playing of the plurality of images in turn; and restore, in response to satisfying a set condition, playing the plurality of images in turn. The set condition includes at least one of the following: the object material moving to the region of the second recommendation information inserted into the news feed, receiving a trigger closing operation on the object material, or display duration of the object material reaching a duration threshold.

In some embodiments, the control module 5552 is further configured to shield, before the object material of the object recommended by the first recommendation information is displayed, response to a trigger operation on the news feed; and restore, in response to satisfying the set condition, response to the trigger operation on the news feed.

In some embodiments, the first recommendation information is located at a first location of the news feed, and the second recommendation information is located at a second location of the news feed. The playing module 5555 is further configured to play a video including the object material of the object recommended by the first recommendation information, where duration of the video is consistent with duration for which the news feed moves from the first location to the second location.

The descriptions of the apparatus in the embodiments of the present disclosure are similar to the descriptions of the foregoing method embodiments and have beneficial effects similar to those of the method embodiments. Therefore, details are not described. Technical details not mentioned in the information recommendation apparatus provided in the embodiments of the present disclosure may be understood according to the descriptions of FIG. 3 or FIG. 5.

An embodiment of the present disclosure provides a computer program product. The computer program product includes a computer program or computer-executable instructions. The computer program or the computer-executable instructions are stored in a computer-readable storage medium. A processor of a computer device reads the computer-executable instructions from the computer-readable storage medium. The processor executes the computer-executable instructions, to cause the computer device to perform the foregoing information recommendation method provided in the embodiments of the present disclosure.

An embodiment of the present disclosure provides a computer-readable storage medium, having computer-executable instructions stored therein. The computer-executable instructions, when executed by a processor, cause the processor to perform the information recommendation method in the embodiments of the present disclosure, for example, the information recommendation method shown in FIG. 3 or FIG. 5.

In some embodiments, the computer-readable storage medium may be a memory such as ferroelectric RAM (FRAM), ROM, programmable ROM (PROM), erasable programmable ROM (EPROM), electrically erasable programmable ROM (EEPROM), flash memory, magnetic surface memory, optical disk, or compact disc (CD-ROM). It may alternatively be a device that includes one or any combination of the above memory types.

In some embodiments, the executable instructions may be written in any form of programming language (including a compiled or interpreted language, or a declarative or procedural language) by using the form of a program, software, a software module, a script, or code and may be deployed in any form, including being deployed as an independent program or being deployed as a module, a component, a subroutine, or another unit suitable for use in a computing environment.

In various embodiments in the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms.

In some other embodiments, a computer-readable medium comprising instructions which, when executed by a computer, cause the computer to carry out a portion or all of the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

In an example, the executable instructions may be deployed to be executed on the electronic device, deployed to be executed on a plurality of electronic devices at the same location, or deployed to be executed on a plurality of electronic devices that are distributed in a plurality of locations and interconnected by using a communication network.

The foregoing descriptions are merely embodiments of the present disclosure and are not intended to limit the protection scope of the present disclosure. Any modification, equivalent replacement, or improvement made without departing from the spirit and range of the present disclosure shall fall within the protection scope of the present disclosure.

What is claimed is:

1. An information recommendation method, performed by an electronic device, the method comprising:
displaying a news feed in a news feed interface, wherein first recommendation information is inserted into the news feed;
displaying an object material of an object recommended by the first recommendation information;
controlling, in response to a slide operation on the news feed interface, the object material to move; and
controlling, in response to the object material moving to a region of second recommendation information in the news feed, the object material to generate at least one piece of interaction content with the second recommendation information, and an object recommended by the second recommendation information being the same as or similar to the object recommended by the first recommendation information.

2. The method according to claim 1, wherein the displaying the object material of the object recommended by the first recommendation information comprises:
displaying the object material of the object recommended by the first recommendation information in a manner of covering at least a part of the first recommendation information.

3. The method according to claim 1, wherein the displaying the object material of the object recommended by the first recommendation information comprises:
displaying, in response to display duration of the first recommendation information reaching a duration threshold, the object material of the object recommended by the first recommendation information, and displaying an atmosphere material related to the object material around the object material.

4. The method according to claim 1, wherein the controlling, in response to the slide operation on the news feed interface, the object material to move comprises:
controlling, in response to the slide operation on the news feed interface, the news feed to move in a slide direction of the slide operation in the news feed interface, and controlling the object material to move in a reverse direction of the slide direction.

5. The method according to claim 1, wherein the controlling, in response to the slide operation on the news feed interface, the object material to move comprises:
keeping, in response to the slide operation on the news feed interface, the news feed still in the news feed interface, and controlling the object material to move in a slide direction of the slide operation or a reverse direction of the slide direction.

6. The method according to claim 1, wherein the controlling the object material to generate at least one piece of interaction content with the second recommendation information comprises:
controlling the object material to be displayed in a hover box at a target location in the region of the second recommendation information, wherein the target location comprises one of the following: a central location in the region of the second recommendation information or a selected location in the region of the second recommendation information.

7. The method according to claim 1, wherein the controlling the object material to generate at least one piece of interaction content with the second recommendation information comprises:
controlling the object material to stay in the region of the second recommendation information; and
controlling, in response to stay duration of the object material reaching a duration threshold, a size of the object material to decrease, and controlling transparency of the object material to increase, until the object material disappearing from the region of the second recommendation information.

8. The method according to claim 1, wherein the controlling the object material to generate at least one piece of interaction content with the second recommendation information comprises:
performing a copy operation on the object material, to obtain a plurality of object materials; and
controlling the plurality of object materials to move in the region of the second recommendation information, wherein when any one of the object materials moves to an edge of the region of the second recommendation information, the object material is controlled to move in a reverse direction.

9. The method according to claim 1, wherein the displaying the object material of the object recommended by the first recommendation information comprises:
controlling the object material to appear at an edge of a region of the first recommendation information, and controlling the object material to move outward the region of the first recommendation information.

10. The method according to claim 1, further comprising:
controlling, during controlling the object material to move, the news feed to be in tilt due to an impact of the object material.

11. The method according to claim 10, wherein the controlling the news feed to be in tilt due to the impact of the object material comprises:
obtaining a configuration parameter preset for the news feed, wherein the configuration parameter comprises: a time function, a Bezier curve parameter, and a transform matrix; and
when the news feed receives the impact of the object material, playing, based on the configuration parameter, an animation in which the news feed is in tilt, wherein the time function is configured for controlling duration of the animation, the Bezier curve parameter is configured for controlling presentation of the animation, and the transform matrix is configured for controlling a degree of the tilt.

12. The method according to claim 10, wherein in response to the object material moving to the region of the second recommendation information in the news feed, the method further comprises:
controlling the news feed to restore from a tilt state to an initial state, wherein the initial state is a state in which the news feed is displayed in the news feed interface in a straight manner.

13. The method according to claim 1, further comprising:
switching, in response to a trigger operation on the first recommendation information or the second recommendation information, from the news feed interface to an association interface associated with the object material.

14. The method according to claim 1, wherein
the first recommendation information comprises a plurality of images configured for recommending the object material, and the first recommendation information is displayed by playing the plurality of images in turn; and
the method further comprises:
stopping, before the object material of the object recommended by the first recommendation information is displayed, playing the plurality of images in turn; and
restoring, in response to satisfying a condition, playing the plurality of images in turn, wherein the condition comprises at least one of the following: the object material moving to the region of the second recommendation information in the news feed, receiving a trigger closing operation on the object material, or display duration of the object material reaching a duration threshold.

15. The method according to claim 14, further comprising:
shielding, before the object material of the object recommended by the first recommendation information is displayed, response to a trigger operation on the news feed; and
restoring, in response to satisfying the condition, response to a trigger operation on the news feed.

16. The method according to claim 1, wherein
the first recommendation information is located at a first location of the news feed, and the second recommendation information is located at a second location of the news feed; and
the displaying the object material of the object recommended by the first recommendation information comprises:
playing a video comprising the object material of the object recommended by the first recommendation information, wherein duration of the video is consistent with duration for which the news feed moves from the first location to the second location.

17. An apparatus for determining a target image region of a target object in a target image, the apparatus comprising:
a memory storing instructions; and
a processor in communication with the memory, wherein, when the processor executes the instructions, the processor is configured to cause the apparatus to perform:
displaying a news feed in a news feed interface, wherein first recommendation information is inserted into the news feed;
displaying an object material of an object recommended by the first recommendation information;
controlling, in response to a slide operation on the news feed interface, the object material to move; and
controlling, in response to the object material moving to a region of second recommendation information in the news feed, the object material to generate at least one piece of interaction content with the second recommendation information, and an object recommended by the second recommendation information being the same as or similar to the object recommended by the first recommendation information.

18. The apparatus according to claim 17, wherein, when the processor is configured to cause the apparatus to perform controlling the object material to generate at least one piece of interaction content with the second recommendation information, the processor is configured to cause the apparatus to perform:
controlling the object material to stay in the region of the second recommendation information; and
controlling, in response to stay duration of the object material reaching a duration threshold, a size of the object material to decrease, and controlling transparency of the object material to increase, until the object material disappearing from the region of the second recommendation information.

19. A non-transitory computer-readable storage medium, storing computer-readable instructions, wherein, the computer-readable instructions, when executed by a processor, are configured to cause the processor to perform:
displaying a news feed in a news feed interface, wherein first recommendation information is inserted into the news feed;
displaying an object material of an object recommended by the first recommendation information;
controlling, in response to a slide operation on the news feed interface, the object material to move; and
controlling, in response to the object material moving to a region of second recommendation information in the news feed, the object material to generate at least one piece of interaction content with the second recommendation information, and an object recommended by the second recommendation information being the same as or similar to the object recommended by the first recommendation information.

20. The non-transitory computer-readable storage medium according to claim 19, wherein, when the computer-readable instructions are configured to cause the processor to perform controlling the object material to generate at least one piece of interaction content with the second recommendation information, the computer-readable instructions are configured to cause the processor to perform:
controlling the object material to stay in the region of the second recommendation information; and
controlling, in response to stay duration of the object material reaching a duration threshold, a size of the object material to decrease, and controlling transparency of the object material to increase, until the object material disappearing from the region of the second recommendation information.
